(19) United States
(12) Patent Application Publication
(10) Pub. No.: US 2010/0218636 A1
(43) Pub. Date: Sep. 2, 2010

(54) BRAKE LEVER ASSEMBLY FOR A BICYCLE

(76) Inventor: Chester Wen, Chang Hua Hsien (TW)

Correspondence Address: Chien-Hui Su, P. O. Box 70-121 Taichung, Taichung City, 40899, TW

(21) Appl. No.: 12/703,776

(22) Filed: Feb. 11, 2010

(30) Foreign Application Priority Data
Feb. 27, 2009 (TW) 098106480

(51) Int. Cl. G05G 1/00

(52) U.S. Cl. 74/491

(57) ABSTRACT

A brake lever assembly for a bicycle includes a pull lever having a pivot hole defined in one end thereof. The pull lever has a pivot bearing received in the pivot hole. A hollow holder is movably connected to the pull lever. The hollow holder has a retaining slot defined therein for retaining the end of the pull lever. The hollow holder has two guiding gutters defined therein for receiving the pivot bearing. A brake seat is connected to the hollow holder and mounted on a handlebar of a bicycle. A hydraulic mechanism is mounted between the pull lever and the brake seat. When the pull lever is pivotally rotated relative to the hollow holder, the pivot bearing simultaneously slides along the two guiding gutters, and the hydraulic mechanism is simultaneously actuated by a movement of the pull lever.

### BACKGROUND OF THE INVENTION

1. Field of the Invention

The present invention relates to a brake lever assembly for a bicycle, and more particularly to a brake lever assembly for a bicycle with a slidable pivot bearing, which is provided for a force-saving effect.

2. Description of Related Art

A conventional brake handle in accordance with the prior art comprises a brake handle which is composed of a brake body, a brake lever and a rotatable disk. A semi-circular slot is defined within the brake body and the brake lever, respectively. The rotatable disk is disposed between the brake body and the brake lever. Wherein the rotatable disk can be partially inserted into the slot of the brake body and the rotatable disk can be further partially inserted into the slot of the brake lever, such that the brake body and the brake lever can be locked together. The rotatable disk comprises an annular groove defined in a periphery thereof for receiving a brake cable, and an opening defined in one side of the rotatable disk for receiving a brake cable nipple. The brake cable is connected to the brake via the brake body. Whereby, a force which is applied to the brake lever is transferred via the rotatable disk to act on the brake cable in such a manner that a rotation force from the brake cable is in line with a passage in the brake body and tangent to the rotatable disk.

The brake handle brake can have a longer moving distance of the brake cable, when the brake lever is pressed. However, an operator still needs to apply enough force on the brake lever to make a rotation movement of the brake cable for stopping the bicycle. And the brake lever may not rotate smoothly due to the combination of the brake lever, the rotatable disk and the brake body. Therefore, it is not convenient to operate the brake handle.

The present invention has arisen to mitigate and/or obviate the disadvantages of the conventional brake handle.

### SUMMARY OF THE INVENTION

The main objective of the present invention is to provide an improved brake lever assembly for a bicycle.

To achieve the objective, the brake lever assembly for a bicycle in accordance with the present invention includes a pull lever which has a pivot hole defined in one end thereof and extending therethrough. The pull lever has a pivot bearing pivotally and partially received in the pivot hole. The pivot bearing includes a pivot shaft pivotally and partially received in the pivot hole of the pull lever. Two ends of the pivot shaft protrude from the pivot hole and two rings are respectively sleeved onto the two ends of the pivot shaft.

A hollow holder is movably connected to the pull lever. The hollow holder has a retaining slot defined in an inner periphery thereof and extending along an axial direction thereof for movably retaining the end of the pull lever. The holder has two guiding gutters oppositely defined in an inner periphery of the retaining slot and extending through the holder along a radial direction of the holder for slidably and partially receiving the pivot bearing. Each guiding gutter has two blocking surfaces oppositely formed on two inner lateral surfaces thereof. Each guiding gutter has a length in the radial direction of the holder relatively greater than a width in the axial direction of the holder. The two rings are respectively and slidably received in the two guiding gutters of the holder. Each ring has an outer diameter corresponding to the width of each guiding gutter.

A brake seat is coaxially connected to the hollow holder and adapts to be mounted on a handlebar of a bicycle. The brake seat has a connecting portion formed on one end thereof and located opposite to the holder for adapting to connecting to the handlebar.

A hydraulic mechanism is mounted between the pull lever and the brake seat. The hydraulic mechanism includes an oil tank disposed on the brake seat. The hydraulic mechanism includes an elastomer and a piston assembly coaxially orderly received in the brake seat. A pressing rod is partially and coaxially received between the brake seat and the pull lever. The pressing rod has two ends respectively connected to the brake lever and the piston assembly, such that the pressing rod simultaneously moves with the brake lever.

When the pull lever is operated to pivotally rotate about an axis of the pivot bearing relative to the hollow holder by applying a force, the pivot bearing simultaneously slides along the two guiding gutters for changing a distance between the axis of the pivot bearing and a central axis of the hydraulic mechanism, and the pressing rod of the hydraulic mechanism is simultaneously pushed by a movement of the pull lever to axially push the piston assembly. The elastomer is compressed by the piston assembly. The distance between the axis of the pivot bearing and the central axis of the hydraulic mechanism is variable for saving the force applied on the pull lever.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a brake lever assembly for a bicycle in accordance with the present invention;

FIG. 2 is an assembled perspective view of the brake lever assembly for a bicycle in accordance with the present invention;

FIG. 3 is a cross-sectional top view of the brake lever assembly for a bicycle in accordance with the present invention; and

FIG. 4 is a cross-sectional top view of the brake lever assembly for a bicycle in accordance with the present invention as a pull lever is pivotally rotated.

### DETAILED DESCRIPTION OF THE INVENTION

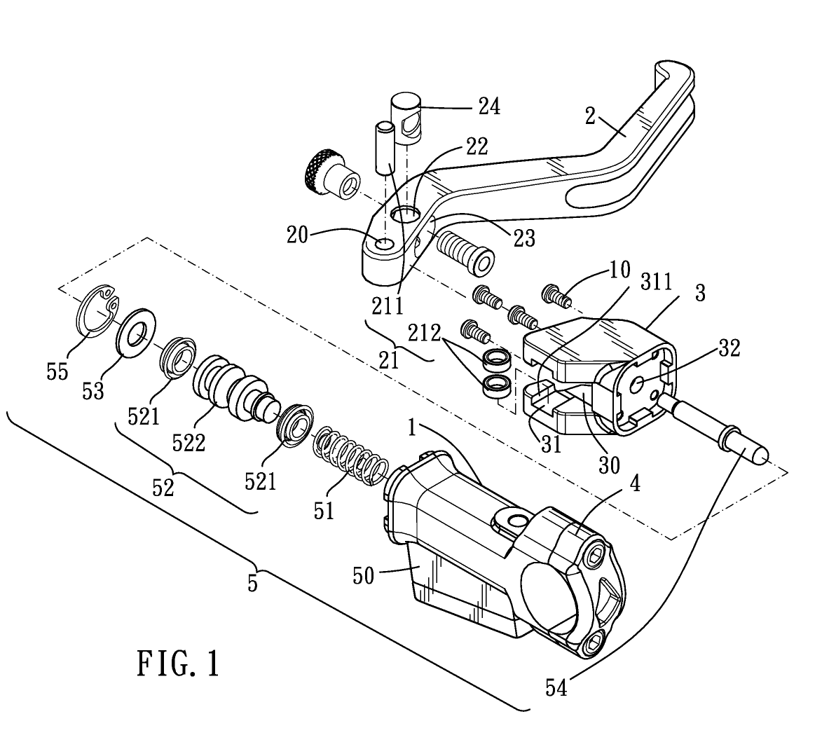

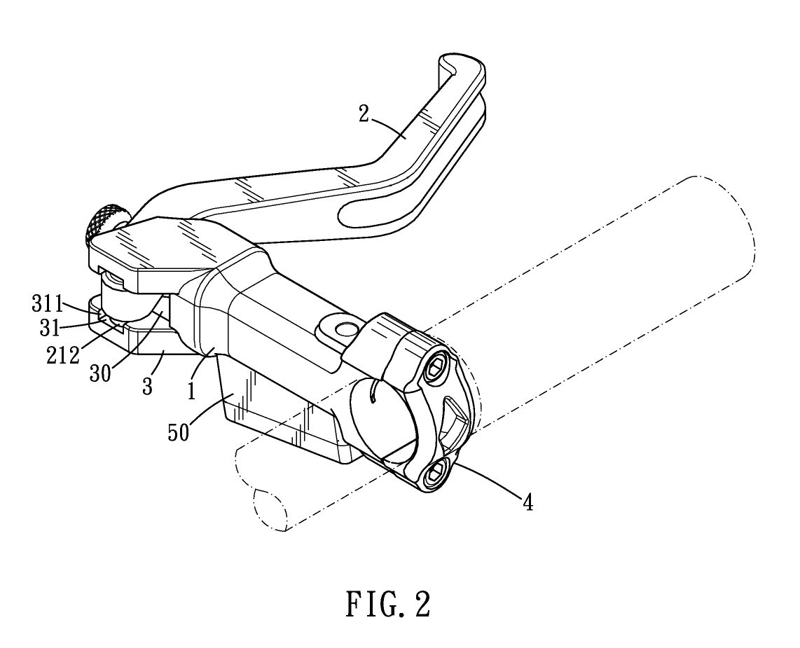

Referring to the drawings and initially to FIGS. 1-2, a brake lever assembly for a bicycle in accordance with the present invention comprises a pull lever 2 having a pivot hole 20 which is defined in one end thereof and vertically extends therethrough. The pull lever 2 has a pivot bearing 21 which is pivotally and partially received in the pivot hole 20. The pivot bearing 21 includes a pivot shaft 211 passing through the pivot hole 20 of the pull lever 2 and two ends of the pivot shaft 211 protrude from the pivot hole 20. Two rings 212 are respectively sleeved onto the two ends of the pivot shaft 211.

The pull lever 2 has a positioning hole 22 which is defined therein and vertically extends through the pull lever 2. The positioning hole 22 is located adjacent to the pivot hole 20. A cylinder 24 is received in the positioning hole 22 and is able to pivotally rotate relative to the pull lever 2. The pull lever 2 has a receiving hole 23 defined therein and communicating with the positioning hole 22. The receiving hole 23 is perpendicular to the positioning hole 22.

A hollow holder 3 is movably connected to the pull lever 2. The hollow holder 3 has a through hole 32 defined therein and extending along an axial direction of the hollow holder 3. The hollow holder 3 has a retaining slot 30 laterally defined in an inner periphery thereof and extending along an axial direction of the holder 3 for movably retaining the end of the pull lever 2.

Moreover, the holder 3 has two guiding gutters 31 oppositely laterally defined in an inner periphery of the retaining slot 30 and facing each other. Each of the two guiding gutters 31 extends through the holder 3 along a radial direction of the holder 3 and has two blocking surfaces 311 oppositely formed on two inner lateral surfaces of the guiding gutter 31. Each guiding gutter 31 has a length in the radial direction of the holder 3 relatively greater than a width of the guiding gutter 31 in the axial direction of the holder 3. Each guiding gutter 31 has a margin space (not numbered) defined therein, such that the pull lever 2 is able to pivotally rotate in the margin space. The two rings 212 of the pivot bearing 21 are respectively and slidably received in the two guiding gutters 31 of the holder 3. Each ring 212 has an outer diameter which corresponds to the width of the guiding gutter 31.

A brake seat 1 is coaxially connected to the hollow holder 3 via a plurality of fasteners 10. The brake seat 1 has a connecting portion 4 formed on one end thereof and located opposite to the hollow holder 3 for adapting to connect to a handlebar of a bicycle.

A hydraulic mechanism 5 is coaxially and movably mounted between the pull lever 2 and the brake seat 1. The hydraulic mechanism 5 has an oil tank 50 disposed on the brake seat 1 for providing oil or other lubricants. The hydraulic mechanism 5 includes an elastomer 51, a piston assembly 52, a washer 53 and a C-shaped ring 55 coaxially orderly received in the brake seat 1. The piston assembly 52 includes a piston 522 and two seals 521 which are respectively disposed on two end of the piston 522. The two seals 521 can prevent oil or other lubricants from leaking out of the piston assembly 52. The elastomer 51 is compressible and has two ends respectively abutting against the brake seat 1 and one of the two seals 521.

The hydraulic mechanism 5 includes a pressing rod 54 passing through the washer 53, the C-shaped ring 55 and the through hole 32 of the holder 3 to be coaxially received between the brake seat 1 and the pull lever 2. The C-shaped ring 55 is located between the holder 3 and the washer 53 for retaining the pressing rod 54 in place. The pressing rod 54 has one end abutting against the piston assembly 52 and the other end which is received in the receiving hole 23 and perpendicularly mounted to the cylinder 24.

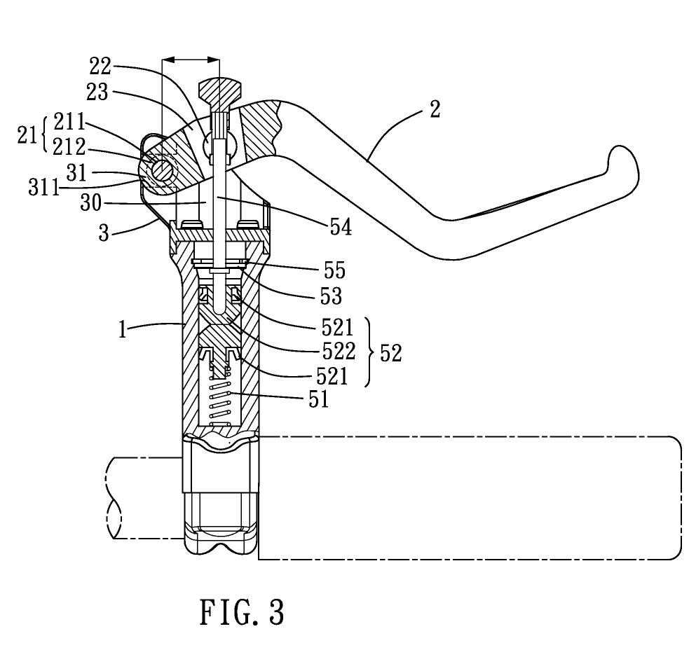

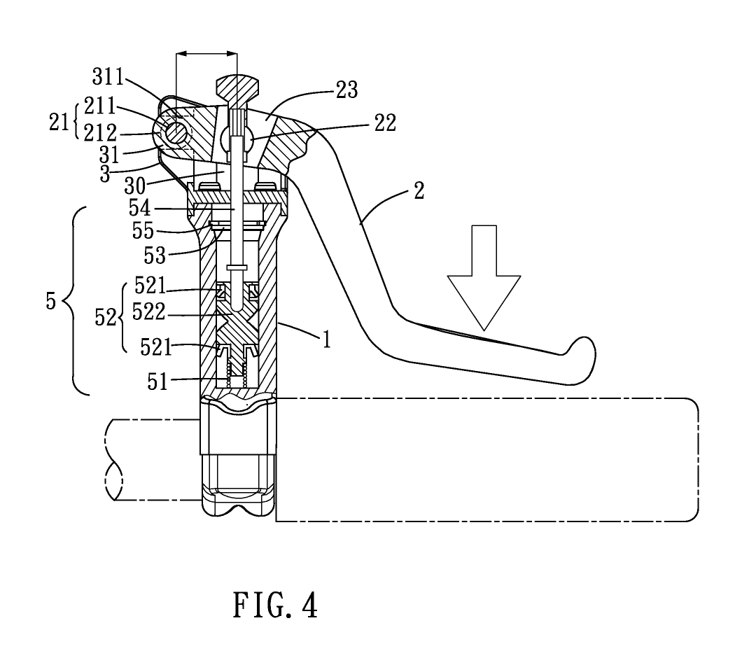

The operation of the brake lever assembly for a bicycle in accordance with the present invention will be described in detailed below. As shown in FIGS. 3-4, when the pull lever 2 is pivotally rotated about an axis of the pivot bearing 21 relative to the holder 3 by applying a force, the two rings 212 of the pivot bearing 21 are restricted by the two blocking surfaces 311 of each guiding gutter 31, and the pivot bearing 21 simultaneously slides outwardly along the two guiding gutters 31. The pressing rod 54 of the hydraulic mechanism 5 is simultaneously actuated by a movement of the pull lever 2 to axially push the piston assembly 52, and the elastomer 51 is compressed by the piston assembly 52. A distance between the axis of the pivot bearing 21 and a central axis of the pressing rod 54 is increased, wherein according to the lever principle the pull lever 2 can be operated easily by the force which is relatively small and a force-saving effect is achieved.

When the force which is applied on the pull lever 2 is eliminated, the elastomer 51 returns and pushes back the piston assembly 52. The pressing rod 54 is axially pushed back by the piston assembly 52. The pull lever 2 is pushed by the pressing rod 54 to pivotally rotate back to its original position.

Although the invention has been explained in relation to its preferred embodiment, it is to be understood that many other possible modifications and variations can be made without departing from the spirit and scope of the invention as hereinafter claimed.

What is claimed is:

1. A brake lever assembly for a bicycle comprising:
a pull lever having a pivot hole defined in one end thereof and extending therethrough, the pull lever having a pivot bearing pivotally and partially received in the pivot hole;
a hollow holder movably connected to the pull lever, the holder having a retaining slot defined in an inner periphery thereof and extending along an axial direction thereof for movably retaining the end of the pull lever, the holder having two guiding gutters oppositely defined in an inner periphery of the retaining slot and extending in a radial direction thereof for slidably and partially receiving the pivot bearing;
a brake seat coaxially connected to the holder and adapting to be mounted on a handlebar of a bicycle; and
a hydraulic mechanism mounted between the pull lever and the brake seat;
wherein when the pull lever is pivotally rotated about an axis of the pivot bearing relative to the holder by applying a force, the pivot bearing simultaneously slides along the two guiding gutters for changing a distance between the axis of the pivot bearing and a central axis of the hydraulic mechanism, and the hydraulic mechanism is simultaneously actuated by a movement of the pull lever, such that the distance between the axis of the pivot bearing and the central axis of the hydraulic mechanism is variable for saving the force applied on the pull lever.

2. The brake lever assembly for a bicycle as claimed in claim 1, wherein each guiding gutter extends through the holder in the radial direction and has two blocking surfaces oppositely formed on two inner lateral surfaces thereof.

3. The brake lever assembly for a bicycle as claimed in claim 1, wherein each guiding gutter has a length in the radial direction of the hollow holder relatively greater than a width in the axial direction of the hollow holder.

4. The brake lever assembly for a bicycle as claimed in claim 3, wherein the pivot bearing includes a pivot shaft pivotally and partially received in the pivot hole of the pull lever, two ends of the pivot shaft protruding from the pivot hole and two rings respectively sleeved onto the two ends of the pivot shaft, the two rings respectively and slidably received in the two guiding gutters of the hollow holder, each ring having an outer diameter corresponding to the width of each guiding gutter, such that the pivot bearing simultaneously slides along the two guiding gutters when the pull lever is pivotally rotated relative to the holder.

5. The brake lever assembly for a bicycle as claimed in claim 1, wherein the brake seat has a connecting portion formed on one end thereof and located opposite to the hollow holder for adapting to connecting to the handlebar.

6. The brake lever assembly for a bicycle as claimed in claim 1, wherein the hydraulic mechanism includes an oil tank disposed on the brake seat, an elastomer and a piston assembly coaxially orderly received in the brake seat, a pressing rod partially and coaxially received between the brake seat and the pull lever, the pressing rod having two ends respectively connected to the brake lever and the piston assembly; wherein when the pressing rod simultaneously moves with the brake lever, the pressing rod axially pushes the piston assembly to compress the elastomer.
